(19) United States
(12) Patent Application Publication
(10) Pub. No.: US 2014/0323148 A1
(43) Pub. Date: Oct. 30, 2014

(54) WIDE AREA LOCALIZATION FROM SLAM MAPS

(71) Applicant: QUALCOMM Incorporated, San Diego, CA (US)

(72) Inventors: Dieter Schmalstieg, Graz (AT); Clemens Arth, Judendorf-Strassengel (AT); Johnathan Ventura, Graz (AT); Christian Pirchheim, Graz (AT); Gerhard Reitmayr, Vienna (AT)

(73) Assignee: QUALCOMM Incorporated, San Diego, CA (US)

(21) Appl. No.: 14/139,856

(22) Filed: Dec. 23, 2013

Related U.S. Application Data
(60) Provisional application No. 61/817,782, filed on Apr. 30, 2013.

(51) Int. Cl. H04W 4/04; G01V 3/38

(52) U.S. Cl. CPC H04W 4/04; G01V 3/38
USPC 455/456.1

(57) ABSTRACT

Exemplary methods, apparatuses, and systems for performing wide area localization from simultaneous localization and mapping (SLAM) maps are disclosed. A mobile device can select a first keyframe based SLAM map of the local environment with one or more received images. A respective localization of the mobile device within the local environment can be determined, and the respective localization may be based on the keyframe based SLAM map. The mobile device can send the first keyframe to a server and receive a first global localization response representing a correction to a local map on the mobile device. The first global localization response can include rotation, translation, and scale information. A server can receive keyframes from a mobile device, and localize the keyframes within a server map by matching keyframe features received from the mobile device to server map features.

### CROSS-REFERENCE TO RELATED ACTIONS

This application claims the benefit of U.S. Provisional Application No. 61/817,782 filed on Apr. 30, 2013, and expressly incorporated herein by reference.

### FIELD

The present disclosure relates generally to the field of localization and mapping in a client-server environment.

### BACKGROUND

Mobile devices (e.g., smartphones) may be used to create and track on the fly three dimensional map environments (e.g., Simultaneous Localization and Mapping). However, mobile devices may have limited storage and processing, particularly in comparison to powerful fixed installation server systems. Therefore, the capabilities of mobile devices to accurately and independently determine a feature rich and detailed map of an environment may be limited. Mobile devices may not have a local database of maps, or if a local database does exist, the database may store a limited number of map elements or have limited map details. Especially in large city environments, the memory required to store large wide area maps may be beyond the capabilities of typical mobile devices.

An alternative to storing large maps locally is for the mobile device to access the maps at a server. However, one problem with accessing maps remotely is the potential for long latency when communicating with the server. For example, sending the query data to the server, processing the query, and returning the response data to the mobile device may have associated lag times that make such a system impractical for real world usage. While waiting for a server response, the mobile device may have moved from the position represented by a first server query. As a result, environment data computed and exchanged with the server may be out of date by the time it reaches the mobile device.

### SUMMARY

Embodiments disclosed herein may relate to a method for wide area localization. The method includes initializing, by the mobile device, a keyframe based simultaneous localization and mapping (SLAM) Map of the local environment with the one or more images, wherein the initializing comprises selecting a first keyframe from one of the images. The method further includes determining, at the mobile device, a respective localization of the mobile device within the local environment, wherein the respective localization is based on the keyframe based SLAM Map. The method further includes sending, from the mobile device, the first keyframe to a server and receiving, at the mobile device, a first global localization response from the server.

Embodiments disclosed herein may relate to an apparatus for wide area localization that includes means for initializing, by the mobile device, a keyframe based simultaneous localization and mapping (SLAM) Map of the local environment with the one or more images, wherein the initializing comprises selecting a first keyframe from one of the images. The apparatus further includes means for determining, at the mobile device, a respective localization of the mobile device within the local environment, wherein the respective localization is based on the keyframe based SLAM Map. The apparatus further includes means for sending, from the mobile device, the first keyframe to a server and means for receiving, at the mobile device, a first global localization response from the server.

Embodiments disclosed herein may relate to a mobile device to perform wide area localization, the device comprising hardware and software to initialize, by the mobile device, a keyframe based simultaneous localization and mapping (SLAM) Map of the local environment with the one or more images, wherein the initializing comprises selecting a first keyframe from one of the images. The mobile device can also determine, at the mobile device, a respective localization of the mobile device within the local environment, wherein the respective localization is based on the keyframe based SLAM Map. The mobile device can also send, from the mobile device, the first keyframe to a server and receive, at the mobile device, a first global localization response from the server.

Embodiments disclosed herein may relate to a non-transitory storage medium having stored thereon instructions that, in response to being executed by a processor in a mobile device, execute initializing, by the mobile device, a keyframe based simultaneous localization and mapping (SLAM) Map of the local environment with the one or more images, wherein the initializing comprises selecting a first keyframe from one of the images. The medium further includes determining, at the mobile device, a respective localization of the mobile device within the local environment, wherein the respective localization is based on the keyframe based SLAM Map. The medium further includes sending, from the mobile device, the first keyframe to a server and receiving, at the mobile device, a first global localization response from the server.

Embodiments disclosed herein may relate to a machine-implemented method for wide area localization at a server. In one embodiment one or more keyframes from a keyframe based SLAM Map of a mobile device are received at the server and the one or more keyframes are localized. Localizing can comprise matching keyframe features from the one or more received keyframes to features of the server map. In one embodiment, the localization results are provided to a mobile device.

Embodiments disclosed herein may relate to a server to perform wide area localization. In one embodiment, one or more keyframes from a keyframe based SLAM Map of a mobile device are received at the server and the one or more keyframes are localized. Localizing can comprise matching keyframe features from the one or more received keyframes to features of the server map. In one embodiment, the localization results are provided to a mobile device.

Embodiments disclosed herein may relate to a device comprising hardware and software for wide area localization. In one embodiment, one or more keyframes from a keyframe based SLAM Map of a mobile device are received at the server and the one or more keyframes are localized. Localizing can comprise matching keyframe features from the one or more received keyframes to features of the server map. In one embodiment, the localization results are provided to a mobile device.

Embodiments disclosed herein may relate to a non-transitory storage medium having stored thereon instructions for receiving one or more keyframes from a keyframe based SLAM Map of a mobile device at the server and the one or more keyframes are localized. Localizing can comprise matching keyframe features from the one or more received keyframes to features of the server map. In one embodiment, the localization results are provided to a mobile device.

Other features and advantages will be apparent from the accompanying drawings and from the detailed description.

### BRIEF DESCRIPTION OF THE DRAWINGS

FIG. 1 illustrates an exemplary block diagram of a device configured to perform Wide Area Localization, in one embodiment;

FIG. 2 illustrates a block diagram of an exemplary server configured to perform Wide Area Localization;

FIG. 3 illustrates a block diagram of an exemplary client-server interaction with a wide area environment;

FIG. 4 is a flow diagram illustrating an exemplary method of Wide Area Localization performed at a mobile device;

FIG. 5 is a flow diagram illustrating an exemplary method of Wide Area Localization performed at a server; and

FIG. 6 illustrates an exemplary flow diagram of communication between a server and client performing Wide Area Localization.

### DETAILED DESCRIPTION

The word “exemplary” or “example” is used herein to mean “serving as an example, instance, or illustration.” Any aspect or embodiment described herein as “exemplary” or as an “example” is not necessarily to be construed as preferred or advantageous over other aspects or embodiments.

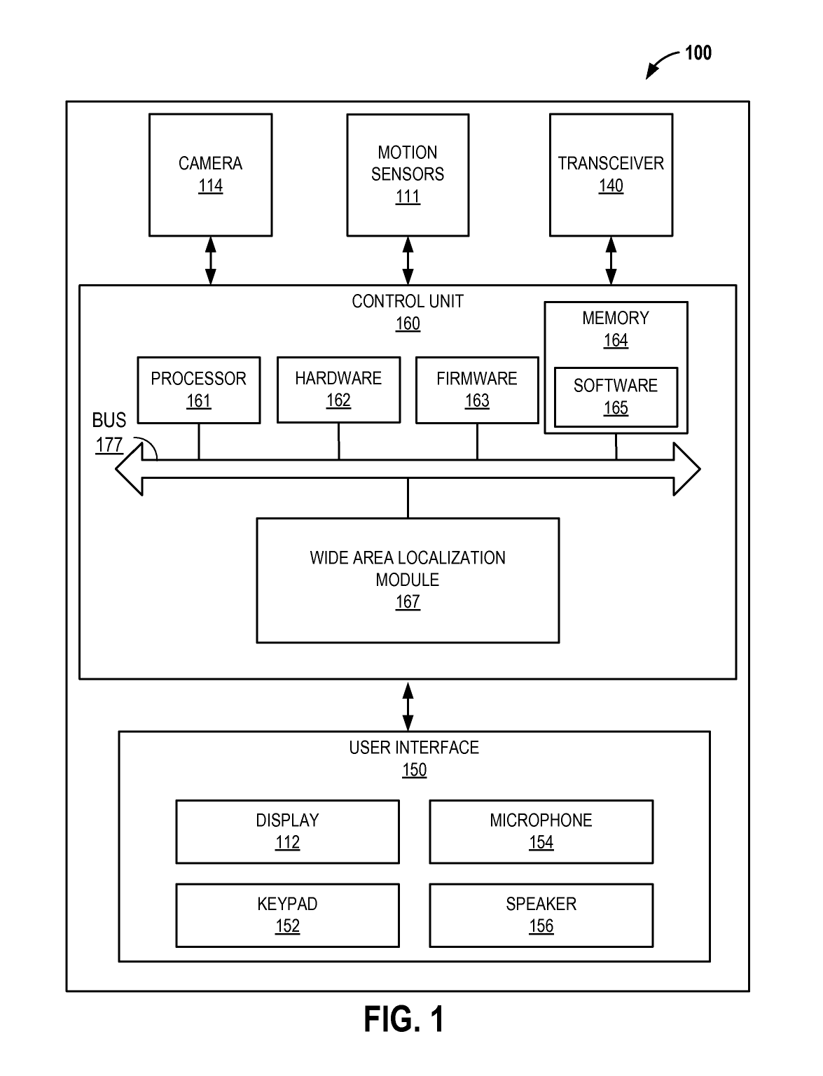

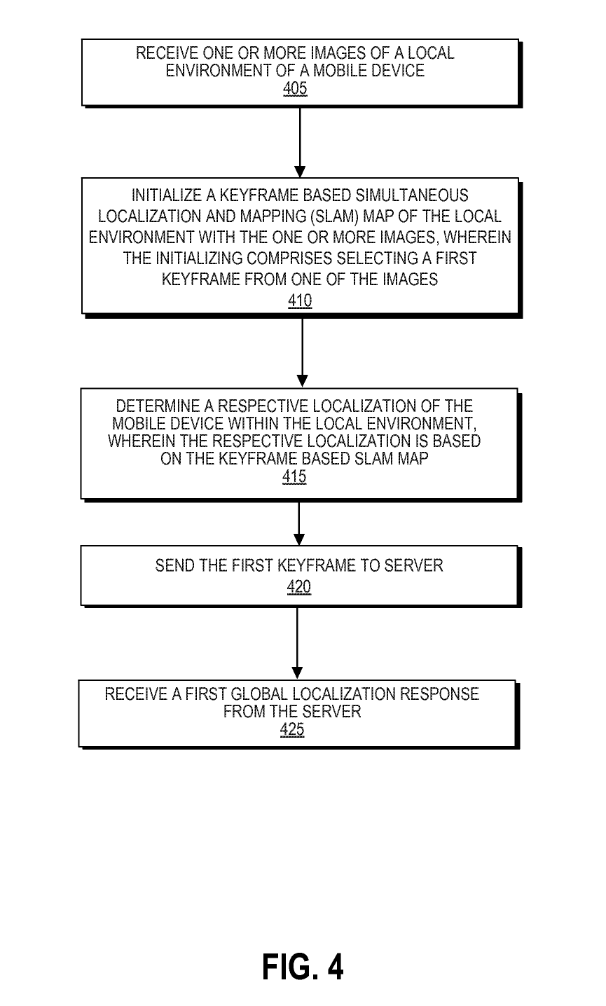

FIG. 1 is a block diagram illustrating a system in which embodiments of the invention may be practiced. The system may be a device 100, which may include a control unit 160. The control unit 160 can include a general purpose processor 161, Wide Area Localization (WAL) module 167, and a memory 164. The WAL Module 167 is illustrated separately from processor 161 and/or hardware 162 for clarity, but may be combined and/or implemented in the processor 161 and/or hardware 162 based on instructions in the software 165 and the firmware 163. Note that control unit 160 can be configured to implement methods of performing Wide Area Localization as described below. For example, the control unit 160 can be configured to implement functions of the mobile device 100 described in FIG. 4 below.

The device 100 may also include a number of device sensors coupled to one or more buses 177 or signal lines further coupled to at least one of the processors or modules. The device 100 may be a: mobile device, wireless device, cell phone, personal digital assistant, wearable device (e.g., eyeglasses, watch, head wear, or similar bodily attached device), robot, mobile computer, tablet, personal computer, laptop computer, or any type of device that has processing capabilities.

In one embodiment, the device 100 is a mobile/portable platform. The device 100 can include a means for capturing an image, such as camera 114 and may optionally include sensors 111 which may be used to provide data with which the device 100 can be used for determining position and orientation (i.e., pose). For example, sensors may include accelerometers, gyroscopes, quartz sensors, micro-electromechanical systems (MEMS) sensors used as linear accelerometers, electronic compass, magnetometers, or other similar motion sensing elements. The device 100 may also capture images of the environment with a front or rear-facing camera (e.g., camera 114). The device 100 may further include a user interface 150 that includes a means for displaying an augmented reality image, such as the display 112. The user interface 150 may also include a keyboard, keypad 152, or other input device through which the user can input information into the device 100. If desired, integrating a virtual keypad into the display 112 with a touch screen/sensor may obviate the keyboard or keypad 152. The user interface 150 may also include a microphone 154 and speaker 156, e.g., if the device 100 is a mobile platform such as a cellular telephone. The device 100 may include other elements such as a satellite position system receiver, power device (e.g., a battery), as well as other components typically associated with portable and non-portable electronic devices.

The device 100 may function as a mobile or wireless device and may communicate via one or more wireless communication links through a wireless network that are based on or otherwise support any suitable wireless communication technology. For example, in some aspects, the device 100 may be a client or server, and may associate with a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, CDMA, TDMA, OFDM, OFDMA, WiMAX, and Wi-Fi. Similarly, a wireless device may support or otherwise use one or more of a variety of corresponding modulation or multiplexing schemes. A mobile wireless device may wirelessly communicate with a server, other mobile devices, cell phones, other wired and wireless computers, Internet web-sites, etc.

As described above, the device 100 can be a portable electronic device (e.g., smart phone, dedicated augmented reality (AR) device, game device, or other device with AR processing and display capabilities). The device implementing the AR system described herein may be used in a variety of environments (e.g., shopping malls, streets, offices, homes or anywhere a user may use their device). Users can interface with multiple features of their device 100 in a wide variety of situations. In an AR context, a user may use their device to view a representation of the real world through the display of their device. A user may interact with their AR capable device by using their device's camera to receive real world images/video and process the images in a way that superimposes additional or alternate information onto the displayed real world images/video on the device. As a user views an AR implementation on their device, real world objects or scenes may be replaced or altered in real time on the device display. Virtual objects (e.g., text, images, video) may be inserted into the representation of a scene depicted on a device display.

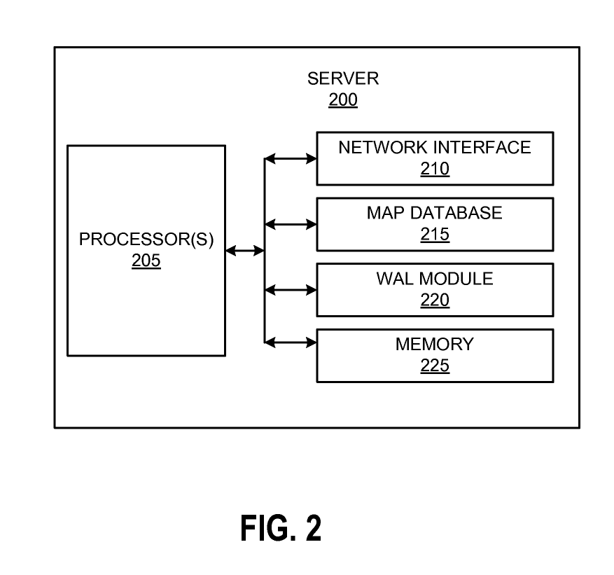

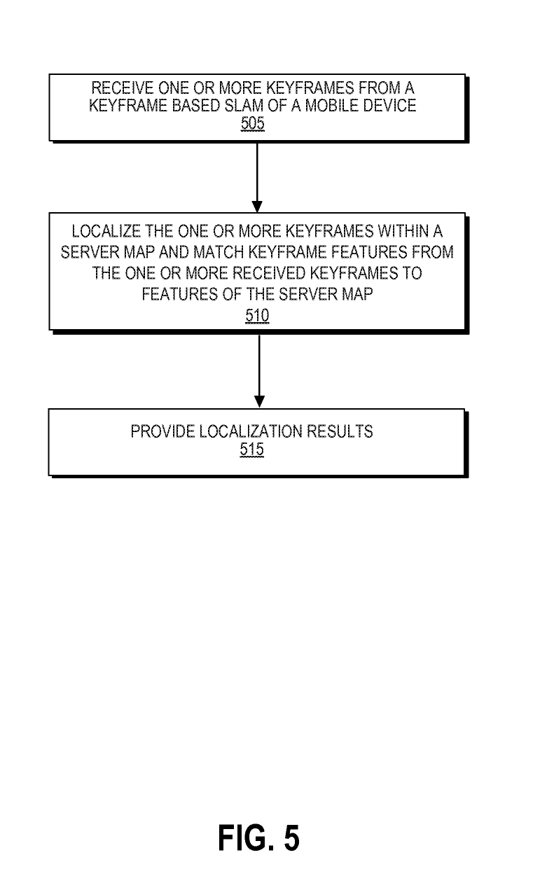

FIG. 2 illustrates a block diagram of an exemplary server configured to perform Wide Area Localization. Server 200 (e.g., WAL Server) can include one or more processors 205, network interface 210, Map Database 215, Server WAL Module 220, and memory 225. The one or more processors 205 can be configured to control operations of the server 200. The network interface 210 can be configured to communicate with a network (not shown), which may be configured to communicate with other servers, computers, and devices (e.g., device 100). The Map Database 215 can be configured to store 3D Maps of different venues, landmarks, maps, and other user-defined information. In other embodiments, other types of data organization and storage (e.g., flat files) can be used to manage the 3D Maps of different venues, landmarks, maps, and other user-defined information as used herein. The Server WAL Module 220 can be configured to implement methods of performing Wide Area Localization using the Map Database 215. For example, the Server WAL Module 220 can be configured to implement functions described in FIG. 5 below. In some embodiments, instead of being a separate module or engine, the Server WAL Module 220 is implemented in software, or integrated into memory 225 of the WAL Server (e.g., server 200). The memory 225 can be configured to store program codes, instructions, and data for the WAL Server.

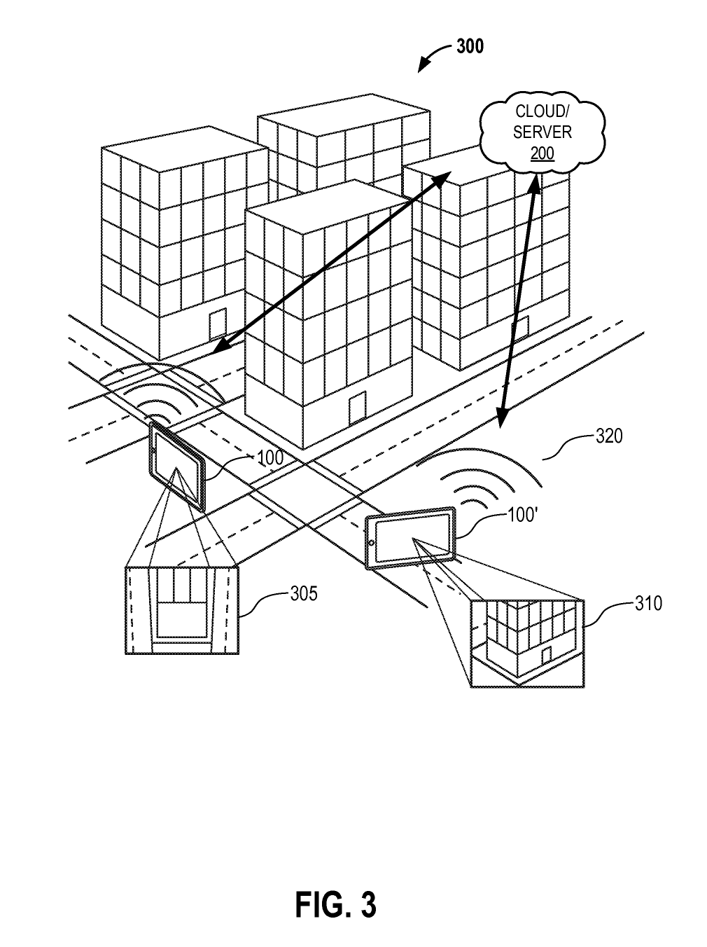

FIG. 3 illustrates a block diagram of an exemplary client-server interaction with a wide area environment. As used herein, wide area can include areas greater than a room or building and may be multiple city blocks, an entire town or city, or larger. In one embodiment, the WAL Client can perform SLAM while tracking a wide area (e.g., wide area 300). While moving to a different sub-location illustrated by the mobile device first position 100 to second position 100′, the WAL Client can communicate over a network 320 with a server 200 (e.g., the WAL Server) or cloud based system. The WAL Client can capture images at different positions and viewpoints (e.g., a first viewpoint 305, and a second viewpoint 310). The WAL Client can send a representation of the viewpoints (e.g., as keyframes) to the WAL Server as described in greater detail below.

In one embodiment, a WAL client-server system (WAL System) can include one or more WAL Clients (e.g., the device 100) and one or more WAL Servers (e.g., WAL Server 200). The WAL System can use the power and storage capacity of the WAL Server, with the local processing capabilities and camera viewpoint of the WAL Client to achieve Wide Area Localization with full six degrees of freedom (6DOF). Relative Localization as used herein refers to determining location and pose of the device 100 or WAL Client. Global Localization as used herein refers to determining location and pose within a wide area map (e.g., the 3D map on the WAL Server).

The WAL Client may use a keyframe based SLAM Map instead of using a single viewpoint (e.g., a image that is a 2D projection of the 3D scene) to query the WAL Server for a Global Localization. Thus, the disclosed method of using information captured from multiple angles may provide localization results within an area that contains many similar features. For example, certain buildings may be visually indistinguishable from certain sensor viewpoints, or a section of a wall may be identical for many buildings. However, upon processing one or more of the mobile device keyframes, the WAL Server may reference the Map Database to determine a Global Localization. An initial keyframe sent by the mobile device may not contain unique or distinguishable information. However, the WAL Client can continue to provide Relative Localization with the SLAM Map on the WAL Client, and the WAL Server can continue to receive updated keyframes and continue to attempt a Global Localization on an incremental basis. In one embodiment, SLAM is the process of calculating the position and orientation of a sensor with respect to an environment, while simultaneously building up a map of the environment (e.g., the WAL Client environment). The aforementioned sensor can be an array of one or more cameras, capturing information from the scene (e.g., the camera 114). The sensor information may be one or a combination of visual information (e.g. standard imaging device) or direct depth information (e.g. passive stereo or active depth camera). An output from the SLAM system can be a sensor pose (position and orientation) relative to the environment, as well as some form of SLAM Map.

A SLAM Map (i.e., Client Map, local/respective reconstruction, or client-side reconstruction) can include one or more of: keyframes, triangulated features points, and associations between keyframes and feature points. A keyframe can consist of a captured image (e.g., an image captured by the device camera 114) and camera parameters (e.g., pose of the camera in a coordinate system) used to produce the image. A feature point (i.e. feature) as used herein is as an interesting or notable part of an image. The features extracted from an image may represent distinct points along three-dimensional space (e.g., coordinates on axes X, Y, and Z) and every feature point may have an associated feature location. Each feature point may represent a 3D location, and be associated with a surface normal and one or more descriptors. Pose detection on the WAL Server can then involve matching one or more aspects of the SLAM Map with the Server Map. The WAL Server can determine pose by matching descriptors from the SLAM Map against the descriptors from the WAL Server database, forming 3D-to-3D correspondences. In some embodiments, the SLAM Map includes at least sparse points (which may include normal information), and/or a dense surface mesh.

As the device 100 moves around, the WAL Client can receive additional image frames for updating the SLAM Map on the WAL Client. For example, additional feature points and keyframes may be captured and incorporated into the SLAM Map on the device 100 (e.g., WAL Client). The WAL Client can incrementally upload data from the SLAM Map to the WAL Server. In some embodiments, the WAL Client uploads keyframes to the WAL Server.

In one embodiment, upon receipt of the SLAM Map from the WAL Client, the WAL Server can determine a Global Localization with a Server Map or Map Database. In one embodiment, the Server Map is a sparse 3D reconstruction from a collection of image captures of an environment. The WAL Server can match 2D features extracted from a camera image to the 3D features contained in the Server Map (i.e. reconstruction). From the 2D-3D correspondences of matched features, the WAL Server can determine the camera pose.

Using the SLAM framework, the disclosed approach can reduce the amount of data to be sent from the device 100 to the WAL Server and reduce associated network delay, allowing live poses of the camera to be computed from the data sent to the WAL Server. This approach also enables incremental information from multiple viewpoints to produce enhanced localization accuracy.

In one embodiment, the WAL Client can initialize a keyframe based SLAM to create the SLAM Map independently from the Server Map of the WAL Server. The WAL Client can extract one or more feature points (e.g., 3D map points associated with a scene) and can estimate a 6DOF camera position and orientation from a set of feature point correspondences. In one embodiment, the WAL Client may initialize the SLAM Map independently without receiving information or being communicatively coupled to the cloud or WAL Server. For example, the WAL Client may initialize the SLAM Map without first reading a prepopulated map, CAD model, markers in the scene, or other predefined descriptors from the WAL Server.

FIG. 4 is a flow diagram illustrating a method of Wide Area Localization performed at a mobile device (e.g., WAL Client), in one embodiment. At block 405, an embodiment (e.g., the embodiment may be software or hardware of the WAL Client or device 100), receives, one or more images of a local environment of the mobile device. For example, the mobile device may have a video feed from a camera sensor containing an image stream.

At block 410, the embodiment initializes a keyframe based Simultaneous Localization and Mapping (SLAM) Map of the local environment with the one or more images. The initializing may include selecting a first keyframe (e.g., an image with computed camera location) from one of the images.

At block 415, the embodiment determines a respective localization (e.g., Relative Localization for determining location and pose) of the mobile device within the local environment. Relative Localization can be based on the keyframe based SLAM Map determined locally on the WAL Client (e.g., mobile device).

At block 420, the embodiment sends the first keyframe to a server. In other embodiments, the WAL Client can send one or more keyframes, as well as corresponding camera calibration information to the server. For example, camera calibration information can include the pose of the camera in the coordinate system used to capture the associated image. The WAL Server can use the keyframes, and calibration information to localize (e.g., determine a Global Localization) at the WAL Server (e.g., within a reconstruction or Server Map).

At block 425, the embodiment receives a first Global Localization response from the server. The Global Localization response may be determined based on matching features points and associated descriptors of the first keyframe to feature points and associated descriptors of the Server Map. The Global Localization response may represent a correction to a local map on the mobile device and can include rotation, translation, and scale information. In one embodiment, the server may consider multiple keyframes simultaneously for matching and determining Global Localization using the Server Map or Map Database. In some embodiments, in response to an keyframe incremental update, the server may send a second or more global localization responses to the mobile device.

In one embodiment, the WAL Client uses a keyframe based SLAM framework of a mobile device in conjunction with a WAL Server. The keyframe based SLAM framework can be executed locally on the WAL Client and can provide continuous relative 6DOF motion detection in addition to the SLAM Map. The SLAM Map can include keyframes (e.g., images with computed camera locations), and triangulated feature points. The WAL Client can use the SLAM Map for local tracking as well as for re-localization if the tracking is lost. For example, if the global localization is lost, the WAL Client can continue tracking using the SLAM Map.

Tracking loss may be determined by the number of features which are successfully tracked in the current camera image. If this number falls below a predetermined threshold then the tracking is considered to be lost. The WAL Client can perform re-localization by comparing the current image directly to keyframe images stored on the WAL Client to find a match. Alternatively, the WAL Client can perform re-localization by comparing features in the current image to features stored on the WAL Client to find matches. Because the images and features can be stored locally on the WAL Client, re-localization can be performed without any communication with the WAL Server.

In one embodiment, new information obtained by the WAL Client (e.g., updates to the SLAM Map) can be sent to the WAL Server to update the Server Map. In one embodiment, the device 100 (also referred to as the WAL Client) can be configured to build up a SLAM environment, while enabling a pose of the device 100 relative to the SLAM environment to be computed by the WAL Server.

In one embodiment, the WAL Client sends one or more keyframes and corresponding camera calibration information to the WAL Server as a Localization Query (LQ). In one embodiment, data (e.g., keyframes) received by the WAL Server since the last LQ may be omitted from the current LQ. LQs that have been previously received by the WAL Server can be stored and cached. This data continuity enables the WAL Server to search over all map points from the WAL Client without all prior sent keyframes having to be retransmitted to the WAL Server. In other embodiments, the WAL Client may send the entire SLAM Map or multiple keyframes with each LQ, which would mean no temporary storage would be required on the WAL Server.

The WAL Server and WAL Client's capability to update a SLAM environment incrementally can enable Wide Area Localization, such as a large city block, incrementally, even though the entire city block may not be captured in a single limited camera view. In addition, sending keyframes of the SLAM environment to the WAL Server as a LQ can improve the ability of the WAL Client to determine global localization because the WAL Server can process a portion of the SLAM Map beginning with the first received LQ.

In addition to using the SLAM framework to localize the device 100, the WAL Client may determine when the LQs are sent to the WAL Server 200. When sending keyframes in an LQ, transfer optimizations may be made. For example, portions of the SLAM environment may be sent to the WAL Server 200 incrementally. In some implementations, as new keyframes are added to the SLAM Map on the WAL Client, a background process can stream one or more keyframes to the WAL Server. The WAL Server may be configured to have session handling capabilities to manage multiple incoming keyframes from one or more WAL Clients. The WAL Server can also be configured to perform Iterative Closest Point (ICP) matching using the Server Map. The WAL Server may incorporate the new or recently received keyframes into the ICP matching by caching previous results (e.g., from descriptor matching).

The WAL Server can perform ICP matching without having the WAL Client reprocess the entire SLAM map. This approach can support incremental keyframe processing (also described herein as incremental updates). Incremental keyframe processing can improve the efficiency of localization (e.g., Respective Localization) compared to localizing within completely new map of the same size. Efficiency improvements may be especially beneficial when performing localization for augmented reality applications. With this approach a stream of new information becomes available as the WAL Client extends the size of the SLAM Map rather than having distinct decision points at which data is sent to the WAL Server. As a result, the disclosed approach optimizes the amount of information sent to the WAL Server as new information may be sent.

FIG. 5 is a flow diagram illustrating a method to perform Wide Area Localization at the WAL Server, in one embodiment. At block 505, an embodiment (e.g., the embodiment may be software or hardware of the WAL Server) receives keyframes from the WAL Client. In one embodiment, the WAL Server can also receive corresponding camera calibration for each keyframe.

At block 510, the embodiment can localize the one or more keyframes within a server map. Keyframes received by the WAL Server can be registered in the same local coordinate system of the SLAM Map. The WAL Server can simultaneously process (i.e., match to other keyframes or the Server Map) multiple keyframes received from one or more WAL Clients. For example, the WAL Server may process a first keyframe from a first client simultaneously with a second keyframe from a second client. The WAL Server may also process two keyframes from the same client at the same time. The WAL Server can link feature points observed in multiple keyframes by epipolar constraints. In one embodiment, the WAL Server can match all feature points from all keyframes to feature points within the Server Map or Map Database. Matching multiple keyframes can lead to a much larger number of candidate matches than from matching a single keyframe to the Server Map. For example, for each keyframe, the WAL Server can compute the 3-point pose. A 3-point pose can be determined by matching features in the keyframe image to the Map Database and finding three or more 2D-3D matches which correspond to a consistent pose estimate.

At block 515, the embodiment can provide the Localization Result to the WAL Client. The WAL Client can use the Localization Result together with the calibration on the WAL Client to provide a scale estimate for the SLAM Map. A single keyframe can be sufficient to determine at least the orientation estimate (e.g., camera orientation) for the SLAM Map with respect to the environment, however the orientation estimate can also be provided by a sensor (e.g., accelerometer or compass) measurement. To determine map scale, the WAL Server can register two keyframes, or one keyframe plus a single 3D point (i.e., feature point) that can be matched correctly in the Server Map (i.e., reconstruction). To verify registration, the WAL Server can compare the relative camera poses from the SLAM Map to the relative camera poses from the keyframe registration process.

In another embodiment, the WAL Client provides a map of 3D points (e.g., the SLAM Map) to the WAL Server. The WAL Server can match the SLAM Map against the Server Map (i.e., reconstruction) and extend the Server Map based on images and points from the SLAM Map from the WAL Client. The extended map can be useful for incorporating new objects or areas that are un-mapped in the Server Map. In one embodiment, the appearance of the Server Map can also be updated with keyframes from the live image feed or video at the WAL Client.

The WAL Client-Server system described above provides real-time accurately-registered camera pose tracking for indoor and outdoor environments. The independence of the SLAM Map on the WAL Client allows for continuous 6DOF tracking during any localization latency period. Because the SLAM system is self-contained at the WAL Client (e.g., device 100), the cost of Global Localization may only occur when the SLAM Map is expanded, and tracking within the SLAM map is possible without performing a global feature lookup.

In one embodiment, the WAL Server maintains a Server Map and/or Map Database 215 composed of keyframes, feature points, descriptors with 3D position information, and potentially surface normals. The WAL Server keyframes, feature points, and descriptors can be similar to the keyframes, feature points, and descriptors determined at the WAL Client. However, the keyframes, feature points, and descriptors on the WAL Server may correspond to portions of 3D maps generated beforehand in an offline process.

Matching aspects of the SLAM Map to the Server Map can be accomplished using an Iterative Closest Point (ICP) algorithm with an unknown scale factor. The WAL Server can use an efficient data structure for matching so that nearest neighbor search between descriptors can be quickly computed. These data structures can take the form of trees (such as K-means, kD-trees, binary trees), hash tables, or nearest neighbor classifiers.

In one embodiment, the WAL Server can compare received descriptors from the WAL Client with the descriptors in the Map Database or Server Map. When the WAL Server determines the descriptors of the WAL Server and the WAL Client are the same type, the WAL Server matches keyframes sent by the WAL Client to keyframes on the WAL Server by finding nearest neighbors of WAL Client descriptors to descriptors in the WAL Server's Map Database. Descriptors on the WAL Server and WAL Client can be vectors representing the appearance of a portion of an object or scene. Possible descriptors may include, but are not limited to, Scale Invariant Feature Transform (SIFT) and Speed Up Robust Features (SURF). The WAL Server can also use additional information priors from client sensors, such as compass information associated with the SLAM Map to further help in determining the nearest neighbors.

In one embodiment, the WAL Server can perform ICP matching and global minimization to provide outlier rejection due to possible misalignment between the SLAM Map and the feature points of the Server Map. In one embodiment, prior to ICP, the WAL Server can perform a dense sampling of the surfaces of the SLAM Map and the Server Map with feature points. The WAL Server can use Patch-based Multi View Stereo algorithms to create denser surface point clouds from both the Server Map and the SLAM Map. The WAL Server may also use dense point clouds for ICP matching. In another embodiment, the WAL Server matches point clouds of the SLAM Map and the Server Map directly assuming common points.

The descriptors of the Map Database on the WAL Server may be different (e.g., of greater processing complexity) than the descriptors calculated by the WAL Client, or alternatively no descriptors may be available. For example, the WAL Client may create a low processor overhead descriptor, while the WAL Server which has a greater processing capability may have a Server Map or Map Database with relatively processor intensive descriptors. In some embodiments, the WAL Server can compute new or different descriptors from the keyframes received from the WAL Client. The WAL Server can compute 3D feature points from one or more keyframes received from the WAL Client. Feature point computation may be performed on the fly while receiving new keyframes from the WAL Client. The WAL Server can use the extracted feature points instead of the feature points received as part of the SLAM Map from the WAL Client.

Feature points may be extracted using a well-known technique, such as SIFT, which localizes feature points and generates their descriptors. Alternatively, other techniques, such as SURF, Gradient Location-Orientation histogram (GLOH), or a comparable technique may be used.

In one embodiment, the Map Database (e.g., Map Database 215 which may be in addition to or include one or more Server Maps) may be spatially organized. For example, the WAL Client's orientation may be determined using embedded device sensors. When matching keyframes within the Map Database, the WAL Server can initially focus on searching for keyframes within a neighborhood of the WAL Client's orientation. In another embodiment, the WAL Server keyframe matching may focus on matching map points for an object captured by the mobile device, and use the initial search result to assist subsequent searches of the Map Database. WAL Server keyframe matching to the Map Database may use approximate location information obtained from GPS, A-GPS, or Skyhook style WiFi position. The various methods described above can be applied to improve the efficiency of matching keyframes in the Map Database.

In one embodiment, if a WAL Client has not initialized a SLAM Map, the WAL Client can use a rotation tracker or gyroscope to detect that insufficient translation has occurred. If there is insufficient translation and no SLAM Map was initialized, the WAL Client can alternatively provide the WAL Server with a single keyframe or panorama image. With a single keyframe or panorama image, the WAL Server can continue to work on global localization while the WAL Client attempts to initialize the local SLAM Map. For example, the WAL Server can perform ICP matching between the Map Database and the single keyframe.

In one embodiment, upon failing to re-localize a first SLAM Map, the WAL Client can start building a second SLAM Map. The WAL Server can use information from the second SLAM Map to provide a Localization Result to the WAL Client. The WAL Client can save the first SLAM Map to memory, and may later merge the first and second SLAM Maps if there is sufficient overlap. The WAL Server can bypass searching for overlaps on a per-feature basis, because the overlaps are a direct result from re-projecting features from the first SLAM Map into the second SLAM Map.

In one embodiment, information from the SLAM Map can be used to update the Server Map. Specifically, the WAL Server can add new features (2d points in the images with descriptors) and points (3d points in the scene, which are linked to the 2d features) from the WAL Client's keyframes that were missing from the current Server Map. Adding features can improve the Server Map and enable the WAL Server to better compensate for temporal variations. For example, the WAL Client may attempt to localize a SLAM Map with keyframes captured during the winter when trees are missing their leaves. The WAL Server can receive the keyframes with trees missing leaves incorporate into the Server Map. The WAL Server may store multiple variations of the Server Map depending on time of year.

In one embodiment, the WAL Server can respond to a LQ with a Localization Response (LR) sent to the WAL Client. The LR may be a status message indicating no localization match was possible to the LQ sent by the WAL Client.

In one embodiment, the WAL Server can respond with an LR that includes rotation, translation, and scale information which represents a correction to the SLAM map to align it with the global coordinate system. Upon receipt of the LR, the WAL Client can transform the SLAM map accordingly. The WAL Server may also send 3D points and 2D feature locations in the keyframe images. The 3D points and 2D feature locations can be used as constraints in the bundle adjustment process, to get a better alignment/correction of the SLAM map using non-linear refinement. This can be used to avoid drift (i.e., change in location over time) in the SLAM map.

The process of syncing the WAL Client Respective Localization with the Global Localization determined at the WAL Server may be relatively slow compared to the frame-rate of the camera, and can take tens of frames before the LR may be received. However, while the WAL Server processes the LQ, the WAL Client may perform visual pose tracking using SLAM relative to the SLAM map origin. Therefore, due to the LQ computing a transformation relative to the SLAM map origin, after the LR has been computed, the relative transformation between object and camera can be computed by chaining the transformation from camera to SLAM map origin, and the transformation from SLAM map origin to a LQ keyframe pose.

In one embodiment, the WAL Client can continue to update the local map while the WAL Server computes a global correction (i.e., Global Localization), and thus the global correction could be outdated by the time it arrives back at the WAL Client. In this case, the transformation provided by the WAL Server can be closely approximated such that the bundle adjustment process of the WAL Client can iteratively move the solution to the optimal global correction.

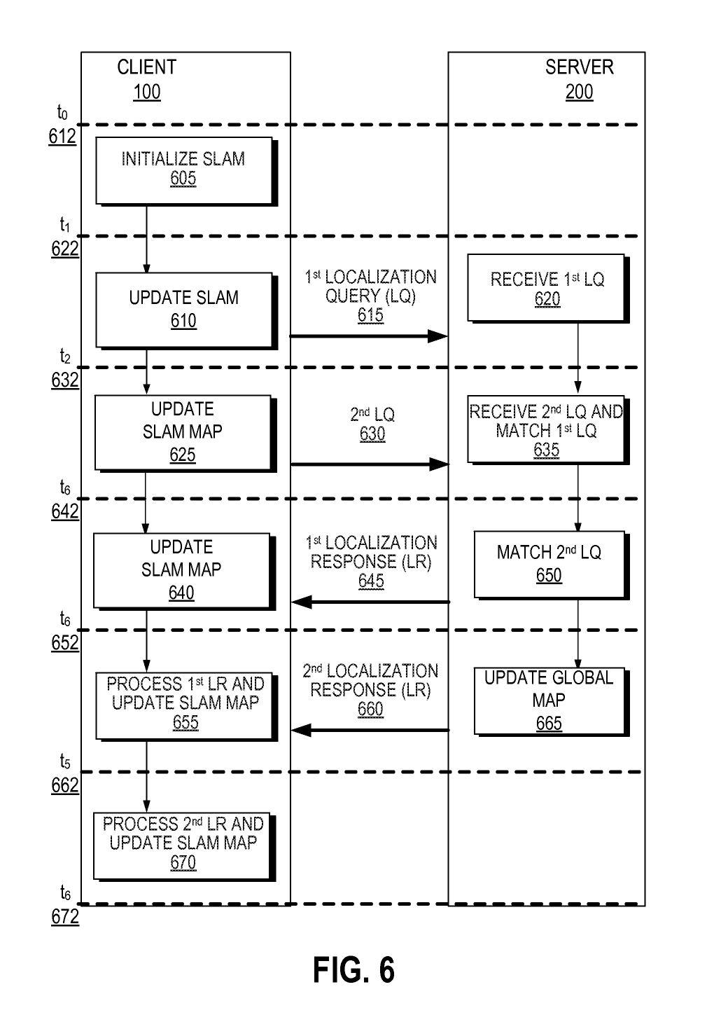

FIG. 6 illustrates an exemplary flow diagram of communication between the WAL Server (e.g., server 200) and WAL Client (e.g., device 100) while performing wide area localization. Sample time periods of t₀ 612 to t₁ 622, t₁ 622 to t₂ 632, t₂ 632 to t₃ 642, t₃ 642 to t₄ 652, t₅ 652 to t₅ 662, and t₅ 662 to t₆ 672 are illustrated in FIG. 6.

During the first time window t₀ 612 to t₁ 622, the WAL Client can initialize SLAM at block 605. SLAM initialization may be consistent with the SLAM initialization as described in greater detail above. Upon initialization the WAL Client can continue to block 610 to update the SLAM Map with extracted information from captured images (e.g., images from integrated camera 114). The WAL Client can continue to capture images and update the local SLAM Map (e.g., blocks 625, 640, 655, and 670) through time t₆ 672 independently of WAL Server operations in blocks 620, 635, 650, and 665.

During the next time window t₁ 622 to t₂ 632, the WAL Client can send a first LQ 615 to the WAL Server. The LQ can include keyframes generated while updating the SLAM Map. The WAL Server, upon receipt of the LQ at block 620, can process the first LQ including one or more keyframes.

During the next time window t₂ 632 to t₃ 642, the WAL Client can continue to update the SLAM Map at block 625. The WAL Client can send a second different LQ 630 to the WAL Server which can include one or more keyframes generated after keyframes sent in the first LQ 615. The WAL Server, upon receipt of the LQ at block 635, can process the first LQ including one or more keyframes. The WAL Server may simultaneously to processing the second LQ, determine a match for the first LQ 615.

During the next time window t₃ 642 to t₄ 652, the WAL Client can and continue to update the SLAM Map at block 640. The WAL Server can send a first Localization Response 645 to the WAL Client upon determining a match or no match of the first LQ to the Server Map or Map Database. The WAL Server can also simultaneously process and match the second LQ 650, to determine a match for the second LQ while sending the first LR 645.

During the next time window t₅ 652 to t₆ 662, the WAL Client can process the first LR from the WAL Server and continue to update the SLAM Map at block 655. The WAL Server can send a second Localization Response 660 to the WAL Client upon determining a match or no match of the second LQ to the Server Map or Map Database. The WAL Server can also update the Server Map and/or Map Database to include updated map information extracted from LQs received from the WAL Client.

During the next time window t₅ 662 to t₆ 672, the WAL Client can process the second LR from the WAL Server and continue to update the SLAM Map at block 670. The WAL Server may continue to send a second Localization Responses (not shown) upon determining a match or no match of the LQs. The WAL Server can also continue to update the Server Map and/or Map Database to include updated map information extracted from LQs received from the WAL Client.

The events of FIG. 6 may occur in a different order or sequence than described above. For example, the WAL Server may update the Server Map as soon as an LQ with updated map information is received.

The device 100 may in some embodiments, include an Augmented Reality (AR) system to display an overlay or object in addition to the real world scene (e.g., provide an augmented reality representation). A user may interact with an AR capable device by using the device's camera to receive real world images/video and superimpose or overlay additional or alternate information onto the displayed real world images/video on the device. As a user views an AR implementation on their device, WAL can replace or alter in real time real world objects. WAL can insert Virtual objects (e.g., text, images, video, or 3D object) into the representation of a scene depicted on a device display. For example, a customized virtual photo may be inserted on top of a real world sign, poster or picture frame. WAL can provide an enhanced AR experience by using precise localization with the augmentations. For example, augmentations of the scene may be placed into a real world representation more precisely because the place and pose of the WAL Client can be accurately determined with the aid of the WAL Server as described in greater detail below.

WAL Client and WAL Server embodiments as described herein may be implemented as software, firmware, hardware, module or engine. In one embodiment, the features of the WAL Client described herein may be implemented by the general purpose processor 161 in device 100 to achieve the previously desired functions (e.g., functions illustrated in FIG. 4). In one embodiment, the features of the WAL Server as described herein may be implemented by the general purpose processor 205 in server 200 to achieve the previously desired functions (e.g., functions illustrated in FIG. 5).

The methodologies and mobile device described herein can be implemented by various means depending upon the application. For example, these methodologies can be implemented in hardware, firmware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. Herein, the term “control logic” encompasses logic implemented by software, hardware, firmware, or a combination.

For a firmware and/or software implementation, the methodologies can be implemented with modules (e.g., procedures, functions, and so on) that perform the functions described herein. Any machine readable medium tangibly embodying instructions can be used in implementing the methodologies described herein. For example, software codes can be stored in a memory and executed by a processing unit. Memory can be implemented within the processing unit or external to the processing unit. As used herein the term “memory” refers to any type of long term, short term, volatile, nonvolatile, or other storage devices and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media may take the form of an article of manufacturer. Computer-readable media includes physical computer storage media and/or other non-transitory media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The disclosure may be implemented in conjunction with various wireless communication networks such as a wireless wide area network (WWAN), a wireless local area network (WLAN), a wireless personal area network (WPAN), and so on. The terms “network” and “system” are often used interchangeably. The terms “position” and “location” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network and so on. A CDMA network may implement one or more radio access technologies (RATs) such as cdma2000, Wideband-CDMA (W-CDMA), and so on. Cdma2000 includes IS-95, IS2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A mobile station refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wire line connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

Designation that something is “optimized,” “required” or other designation does not indicate that the current disclosure applies only to systems that are optimized, or systems in which the “required” elements are present (or other limitation due to other designations). These designations refer only to the particular described implementation. Of course, many implementations are possible. The techniques can be used with protocols other than those discussed herein, including protocols that are in development or to be developed.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations are possible in view of the above teachings. The embodiments were chosen and described to explain the principles of the disclosure and their practical applications, and to enable others skilled in the art to best utilize the disclosure and various embodiments with various modifications as suited to the particular use contemplated.

What is claimed is:

1. A method of performing wide area localization at a mobile device, comprising:
receiving, one or more images of a local environment of the mobile device;
initializing, a keyframe based simultaneous localization and mapping (SLAM) map of the local environment with the one or more images, wherein the initializing comprises selecting a first keyframe from one of the images;
determining, a respective localization of the mobile device within the local environment, wherein the respective localization is based on the keyframe based SLAM map;
sending, the first keyframe to a server; and
receiving, a first global localization response from the server.

2. The method of claim 1, further comprising:
referencing the keyframe based SLAM map to provide relative six degrees of freedom mobile device motion detection.

3. The method of claim 1, wherein the first global localization response is determined based on matching feature points and associated descriptors of the first keyframe to feature points and associated descriptors of a server map, and wherein the first global localization response provides a correction to a local map on the mobile device and includes one or more of: rotation, translation, and scale information.

4. The method of claim 1, wherein the first keyframe sent to the server contains one or more new objects or scenes to extend a server map.

5. The method of claim 1, further comprising:
generating, a second keyframe as a result of the SLAM of the local environment;
sending, the second keyframe to the server as an incremental update; and
receiving, in response to the server receiving the incremental update, a second global localization response from the server.

6. The method of claim 1, further comprising:
displaying, at the mobile device, an augmented reality representation of the local environment upon initializing the keyframe based SLAM map; and
updating the augmented reality representation of the environment while tracking movement of the mobile device.

7. The method of claim 1, wherein the first keyframe comprises a camera image, camera position, and camera orientation when the camera image was captured.

8. A non-transitory storage medium having stored thereon instructions that, in response to being executed by a processor in a mobile device device, perform a method comprising:
receiving, one or more images of a local environment of the mobile device;
initializing, a keyframe based simultaneous localization and mapping (SLAM) map of the local environment with the one or more images, wherein the initializing comprises selecting a first keyframe from one of the images;
determining, a respective localization of the mobile device within the local environment, wherein the respective localization is based on the keyframe based SLAM map;
sending, the first keyframe to a server; and
receiving, a first global localization response from the server.

9. The medium of claim 8, further comprising:
referencing the keyframe based SLAM map to provide relative six degrees of freedom mobile device motion detection.

10. The medium of claim 8, wherein the first global localization response is determined based on matching feature points and associated descriptors of the first keyframe to feature points and associated descriptors of a server map, and wherein the first global localization response provides a correction to a local map on the mobile device which includes one or more of: rotation, translation, and scale information.

11. The medium of claim 8, wherein the first keyframe sent to the server contains one or more new objects or scenes to extend a server map.

12. The medium of claim 8, further comprising:
selecting, a second keyframe from the one or more images of the local environment;
sending, the second keyframe to the server as an incremental update; and
receiving, in response to the server receiving the incremental update, a second global localization response from the server.

13. The medium of claim 8, further comprising:
displaying, at the mobile device, an augmented reality representation of the local environment upon initializing the keyframe based SLAM map; and
updating the augmented reality representation of the environment while tracking movement of the mobile device.

14. The medium of claim 8, wherein the first keyframe comprises a camera image, camera position, and camera orientation when the camera image was captured.

15. A mobile device for performing wide area localization comprising:
means for receiving, one or more images of a local environment of the mobile device;
means for initializing, a keyframe based simultaneous localization and mapping (SLAM) map of the local environment with the one or more images, wherein the initializing comprises selecting a first keyframe from one of the images;
means for determining, a respective localization of the mobile device within the local environment, wherein the respective localization is based on the keyframe based SLAM map;
means for sending, the first keyframe to a server; and
means for receiving, a first global localization response from the server.

16. The mobile device of claim 15, further comprising:
means for referencing the keyframe based SLAM map to provide relative six degrees of freedom mobile device motion detection.

17. The mobile device of claim 15, wherein the first global localization response is determined based on means for matching feature points and associated descriptors of the first keyframe to feature points and associated descriptors of a server map, and wherein the first global localization response provides a correction to a local map on the mobile device which includes one or more of: rotation, translation, and scale information.

18. The mobile device of claim 15, wherein the first keyframe sent to the server contains one or more new objects or scenes to extend a server map.

19. The mobile device of claim 15, further comprising:
means for selecting, a second keyframe from the one or more images of the local environment;
means for sending, the second keyframe to the server as an incremental update; and
means for receiving, in response to the server receiving the incremental update, a second global localization response from the server.

20. The mobile device of claim 15, further comprising:
means for displaying, at the mobile device, an augmented reality representation of the local environment upon initializing the keyframe based SLAM map; and
means for updating the augmented reality representation of the environment while tracking movement of the mobile device.

21. The mobile device of claim 15, wherein the first keyframe comprises a camera image, camera position, and camera orientation when the camera image was captured.

22. A mobile device comprising:
a processor;
a storage device coupled to the processor and configurable for storing instructions, which, when executed by the processor cause the processor to:
receive, at an image capture device coupled to the mobile device, one or more images of a local environment of the mobile device;
initialize, a keyframe based simultaneous localization and mapping (SLAM) map of the local environment with the one or more images, wherein the initializing comprises selecting a first keyframe from one of the images;
determine, a respective localization of the mobile device within the local environment, wherein the respective localization is based on the keyframe based SLAM map;
send, the first keyframe to a server; and
receive, a first global localization response from the server.

23. The mobile device of claim 22, further comprising instructions to:
reference the keyframe based SLAM map to provide relative six degrees of freedom mobile device motion detection.

24. The mobile device of claim 22, wherein the first global localization response is determined based on matching feature points and associated descriptors of the first keyframe to feature points and associated descriptors of a server map, and wherein the first global localization response provides a correction to a local map on the mobile device which includes one or more of: rotation, translation, and scale information.

25. The mobile device of claim 22, wherein the first keyframe sent to the server contains one or more new objects or scenes to extend a server map.

26. The mobile device of claim 22, further comprising instructions to cause the processor to:
select, a second keyframe from the one or more images of the local environment;
send, the second keyframe to the server as an incremental update; and
receive, in response to the server receiving the incremental update, a second global localization response from the server.

27. The mobile device of claim 22, further comprising instructions to cause the processor to:
display, at the mobile device, an augmented reality representation of the local environment upon initializing the keyframe based SLAM map; and
update the augmented reality representation of the environment while tracking movement of the mobile device.

28. The mobile device of claim 22, wherein the first keyframe comprises a camera image, camera position, and camera orientation when the camera image was captured.
